(19) United States
(12) Patent Application Publication
(10) Pub. No.: US 2024/0064142 A1
(43) Pub. Date: Feb. 22, 2024

(54) GROUP AUTHENTICATION BASED ON AGGREGATED CAPABILITIES

(71) Applicant: INTERNATIONAL BUSINESS MACHINES CORPORATION, ARMONK, NY (US)

(72) Inventors: Sushain Pandit, Austin, TX (US); Sarbajit K. Rakshit, Kolkata (IN)

(21) Appl. No.: 17/820,642

(22) Filed: Aug. 18, 2022

(51) Int. Cl. H04L 9/40

(52) U.S. Cl. CPC H04L 63/0884; H04L 63/20

(57) ABSTRACT

A method, computer system, and a computer program for group-based authentication are provided. The method may include evaluating each individual of a group for qualification for task to acquire an aggregate skill score associated with the group. The method may further include determining the aggregate skill score exceeds a group task authentication threshold based on the evaluation and granting the group authorization associated with the task responsive to the determination.

### BACKGROUND

The present invention relates generally to task rendering, and more particularly, to various embodiments for authentication of groups to perform a task based on aggregated capabilities of individuals within the groups.

Authentication and other security mechanisms are necessary in order to not only ensure proper access controls for individuals, but also to validate the credentials/qualifications for said individuals necessary to perform specific activities. However in situations in which a particular activity requires action from multiple individuals, each individual having a unique and different skillset, it is difficult to authenticate and monitor a group for performance of the task in an aggregate manner that assures the multiple individuals are verified.

### SUMMARY

Additional aspects and/or advantages will be set forth in part in the description which follows and, in part, will be apparent from the description, or may be learned by practice of the invention.

A system, method, and computer product for group-based authentication is disclosed herein. In some embodiments, the computer-implemented method for group-based authentication includes evaluating, by a computing device, each individual of a group for qualification for task to acquire an aggregate skill score associated with the group; based on the evaluation, determining, by the computing device, the aggregate skill score exceeds a group task authentication threshold; and responsive to the determination, granting the group authorization associated with the task.

In some embodiments, a server configured to present a centralized platform designed to facilitate group-based authentication is provided. The centralized platform is a virtual reality (VR) and/or augmented reality (AR) system configured to adopt VR/AR technologies for the purpose of training and facilitating workforce functionality to users for completion of the task.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a functional block diagram illustrating a group-based authentication environment according to at least one embodiment;

FIG. 2 illustrates an exemplary authorization module associated with the environment of FIG. 1, according to at least one embodiment;

FIG. 3 illustrates an exemplary block diagram illustrating a data flow associated with the environment of FIG. 1, according to at least one embodiment;

FIG. 4 illustrates an example of task-based grouping of users, according to at least one embodiment;

FIG. 5 illustrates a flowchart depicting a process for group-based authentication, according to at least one embodiment;

FIG. 6 depicts a block diagram illustrating components of the software application of FIG. 1, in accordance with an embodiment of the invention;

FIG. 7 depicts a cloud-computing environment, in accordance with an embodiment of the present invention; and

FIG. 8 depicts abstraction model layers, in accordance with an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for group-based authentication. Selection of individuals for the purpose of completing a task plays an important role in the success of the task at both the individual and group level. Traditionally, the selection process is heavily based on the skills, credentials, amount of experience, etc. of the individual; however, in instances in which the task requires multiple individuals a significant hurdle is added when attempting to ensure that necessary skillsets of each of the multiple individuals are present to complete the task in the most efficient manner. For example in the instance of a mountain rescue mission, ideally a rescue group would need to consist of a medical professional, a pilot for extraction if necessary, a mountain rescue qualified individual, etc. If each of the aforementioned parties are not present then the efficiency of handling the task is impacted. In addition, real-time verification of skills for said parties is difficult due to the fact that the aggregated skill sets of the overall group must be ascertained in order to ensure proper allocation of skill sets (e.g., qualifications, security credentials, etc.) of each individual to perform the task at hand. In particular, issues like skill gaps may be identified during the selection of individuals for groups that must be rectified in a rapid manner in order for the group to accomplish the task efficiently, in which the lack of addressing skill gaps and lack of credentials may be catastrophic depending on the circumstances of the task. Thus, the present embodiments have the capacity to evaluate skillsets of individuals for a particular task in a manner that validates the skillsets for the group in an aggregated fashion and designates group-based authorization to enter and/or complete the task at a particular location based on the validation. The group-based authorization takes-into account policies derived from requirements of the task, capabilities of the group, and even the venue where the task is to be performed. The present embodiments further have the capacity to perform monitoring of the groups for the purpose of ascertaining skill gaps to be quickly corrected in order to ensure completion of the task. Furthermore, virtual reality, augmented reality, and mixed reality environments are provide to facilitate the functioning of the present embodiments.

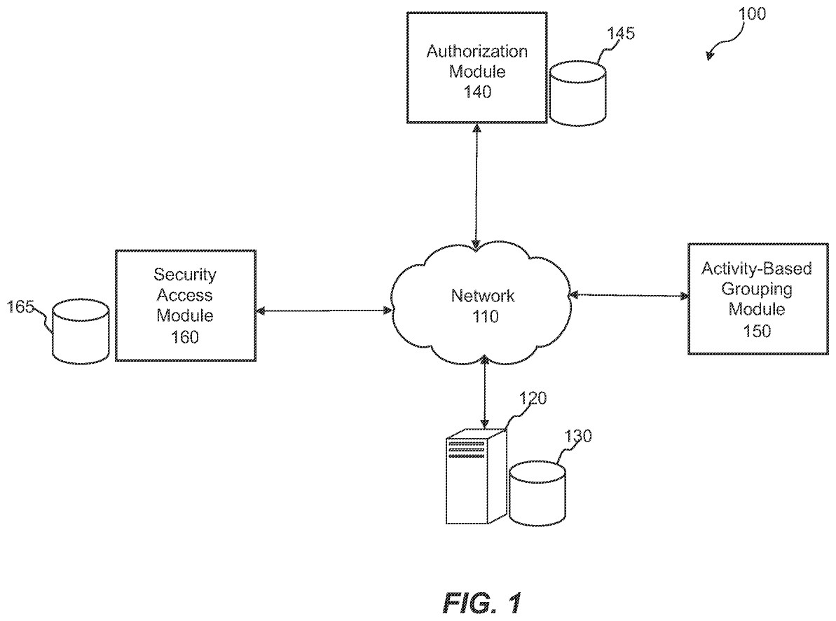

Referring now to FIG. 1, an environment for group-based authentication 100 is depicted according to an exemplary embodiment. FIG. 1 provides only an illustration of implementation and does not imply any limitations regarding the environments in which different embodiments may be implemented. Modifications to environment 100 may be made by those skilled in the art without departing from the scope of the invention as recited by the claims. In some embodiments, environment 100 includes a server 120 communicatively coupled to a database 130, an authorization module 140 communicatively coupled to an authorization database 145, an activity-based grouping module 150, and a security access module 160 communicatively coupled to a security access database 165, each of which are communicatively coupled over a network 110. Network 110 may include various types of communication networks, such as a wide area network (WAN), local area network (LAN), a telecommunication network, a wireless network, a public switched network and/or a satellite network, cloud networks, etc. Some clouds are based upon non-traditional IP networks. Thus, for example, a cloud may be based upon two-tier CLOS-based networks with special single layer IP routing using hashes of MAC addresses. The techniques described herein may be used in such non-traditional clouds. In some embodiments, network 110 may be embodied as a physical network and/or a virtual network. A physical network can be, for example, a physical telecommunications network connecting numerous computing nodes or systems such as computer servers and computer clients. A virtual network can, for example, combine numerous physical networks or parts thereof into a logical virtual network. In another example, numerous virtual networks can be defined over a single physical network. It should be appreciated that FIG. 1 provides only an illustration of one implementation and does not imply any limitations with regard to the environments in which different embodiments may be implemented. Many modifications to the depicted environments may be made based on design and implementation requirements. For example, authorization module 140, activity-based grouping module 150, and security access module 160 may be components of server 120.

It should be noted that the combination of elements of environment 100 render a system configured to designate authorization to users during the process of forming groups for accomplishing a particular task. As described herein, tasks require a particular set of activities to be performed each of which require a particular set of skills from the groups of individual users. Individual users may include human users and/or robotic users. Formulated groups may in some embodiments be configured to share individuals for the purpose of ensuring that the plurality of skills necessary to complete the activities of the task is present. For example, a medical professional included in a first group dedicated towards a mountain rescue mission may also be allocated to a second group dedicated towards a completely separate task associated with a separate group in order to overcome a skill gap for the separate task.

In some embodiments, server 120 is designed to generate a centralized platform configured to allow administrators, admin, users, or any other applicable party to view individual related information (e.g. user data, security credentials, skills/qualifications, etc.), task related information (e.g. required activities, necessary skills, skill gaps, minimum number of individuals required, etc.), group related information (e.g. individual allocation, constraints, etc.), or any other applicable useful information known to those of ordinary skill in the art. In some embodiments, the centralized platform is a virtual reality (VR) and/or augmented reality (AR) system configured to adopt VR/AR technologies for the purpose of training and facilitating workforce functionality to users for completion of the task. The present disclosure provides dynamic creation of groupings of individuals for workforces to complete tasks in which indicators are allocated to individuals within a virtual environment to designate whether authorization module 140 has authorized a particular individual and/or group for performing a task and/or access to a restricted area or resource associated with the task. The indicators may include an assigned color, marking, or any other applicable visual cue to an avatar representative of the individual within the virtual environment. The authorization process is based on data collected by server 120 and/or any of the aforementioned modules in which authorization module 140 evaluates the task authentication credentials of an individual in order to assist activity-based grouping module 150 in grouping individuals and determining an aggregate skill score of a particular group.

Authorization module 140 is designed to utilize one or more authentication processes to analyze identifying credentials in order to verify an individual's identity, credentials, skills/qualifications, etc. for the purpose of authorizing access to one or more of a restricted area/space, computing system, network, resource, and/or device associated with a particular task. In some embodiments, authorization module 140 is configured to assign access credentials to an individual based on the analysis of the identifying credentials, in which access credentials may include a two-dimensional access mechanism (e.g. QR code, NFC tag, Bluetooth beacon, etc.), alpha-numerical code, or any other applicable form of granting access known to those of ordinary skill in the art. As described herein, the term “task” may refer in various embodiments to a job that requires an individual or workforce group, allocated access to a designated area associated with the job, or in some instances system resources including tools, services (e.g. cloud based services, applications, etc.), data (e.g. files, unstructured data, databases, etc.), computing platforms (e.g. application containers, virtual machines, hosts, etc.), and/or any other system entity that may be accessed by another system entity, service or individual termed a “user”. The term “access” in reference to a task pertains to entry to the designated area, tool, service, etc. associated with the task. As described herein, the term “user,” as used herein, may refer to system entities (e.g. human or robot) that are granted access. Users may include individuals, applications, services, computers and/or other physical entities that may access or request access.

In some embodiments, activity-based grouping module 150 is configured to determine workforce allocation based on applicable data received from server 120, authorization module 140, and security access module 160 relating to individuals operating within environment 100. Workforce selection is based on skills and expertise, such as, academic qualification, experience, or knowledge, of individuals, or employees to engage in tasks of a system, or an organization. For example, a mountain rescue mission may require at least one individual with medical qualifications, at least two individuals with mountain climbing skills, and at least one individual with qualifications to operate a helicopter. Activity-based grouping module 150 is configured to evaluate not only the skills/expertise and qualifications of individuals for the purpose of assigning an individual to a group, but also, in various embodiments, to evaluate individual characteristics including but not limited to personality traits, personal values, etc. In some embodiments, activity-based grouping module 150 is communicatively coupled to one or more sensors, e.g. a network of sensors (e.g. IOT sensors, sensors of wearable devices associated with users, accelerometers, gyroscopes, etc.), associated with an individual configured to acquire biological information, movement data, location data, etc. and transmit said data to server 120 over network 110. Skills/expertise and qualifications may be provided to activity-based grouping module 150 by server 120 and/or any applicable trusted third party source. In some instances, data associated with skills, expertise, qualifications, individual characteristics, etc. are provided via user inputs received on the centralized platform. In addition, the centralized platform may allow administrators, admin, etc. to view individual related information, which may be associated with a spreadsheet or other applicable visual depiction included within a dedicated software application with a graphical user interface. In some embodiments, an interactive spreadsheet is provided to users within the virtual reality environment hosted on the centralized platform.

Skills, expertise, qualifications, and individual characteristics provide activity-based grouping module 150 insights relating to formulating groups for a task such as but not limited to probability of collaboration among individuals, ascertaining skill gaps for a task, generating individual-specific analytics based on real-time monitoring (e.g., IOT sensors, etc.) of the individual during performance of one or more of the plurality of activities associated with the task. Activity-based grouping module 150 is further configured to calculate the aggregate skill score which may be based on individual workforce scores calculated for each individual. In some embodiments, the aggregate skill score is based at least in part on one or more group policies in which a group policy is a guideline for security or compliance conditions associated with the task such as but not limited to security credentials, corporate compliances, regulatory compliance, etc. The individual workforce scores are calculated based on the individual's skills/expertise, experience, qualifications, a trait compatibility analysis derived from the individual characteristics, collaboration compatibility scores, collaboration compatibility analysis, and an optimized total fitness score, for the individuals or groups, based on the compatibility analysis and the collaboration compatibility analysis, for performing a specific task.

Security access module 160 is designed to generate group policies pertaining to tasks and access control rules relating to access associated with the tasks. The policies may be based on the details and requirements associated with the task (e.g. required number of individuals, requirements of the plurality of activities, etc.), access group policy parameters reflecting security or compliance conditions associated with the task, and any other applicable rules associated with environment 100 (e.g. system changes/updates, scheduling, dependencies, etc.). In addition, security access module 160 is configured to maintain security access database 165 which is designed to store records relating to access group policies applied to individuals and groups. As described herein, access group policies are sets of controls or permissions that specify the conditions necessary to perform certain operations on the task and/or resource of the task to which it is attached. In some embodiments, access group policies are made up of one or more entries that include user and/or group specific permissions or rights, and the policies may be mapped to particular skillsets, credentials, etc. associated with particular tasks. Security access module 160 is further configured to generate a plurality of security codes, for each individual of the group or the group overall, associated with the restricted area or resource associated with the particular task.

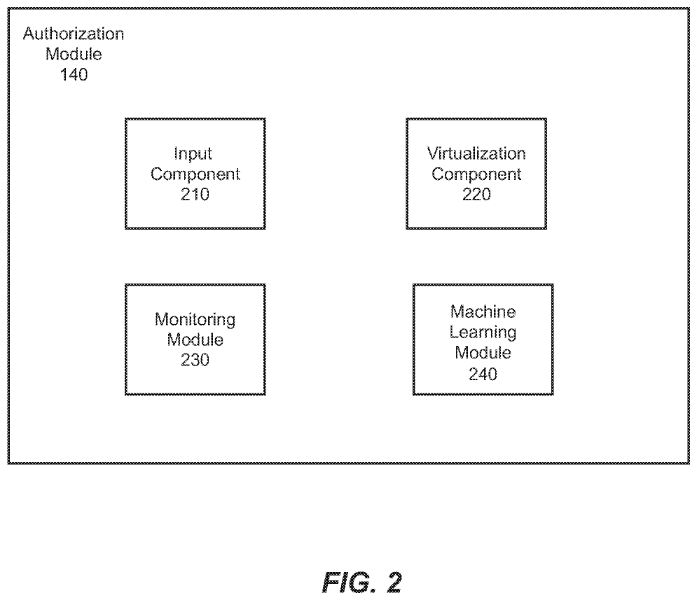

Referring now to FIG. 2, authorization module 140 is depicted, according to an exemplary embodiment. Authorization module 140 includes an input component 210, a virtualization component 220, a monitoring module 230, and a machine learning module 240.

Input component 210 receives data derived from one or more of server 120 and inputs associated with users (e.g. wearable devices, audio/visual entertainment devices, computing devices, image capture devices, keyboards, etc.). Input component 210 is further designed to detect or poll available input devices connected to, in communication with, or accessible by authorization module 140. Virtualization component 220 is utilized to dynamically generate a framework within the virtual reality/augmented reality/mixed reality environment based on user preferences along with present user interactions and indicators associated with the task within the virtual environment. For example, upon authorization module 140 authenticating an individual or group, virtualization component 220 assigns the applicable visual indicator to the applicable individual or group allowing other individuals to ascertain whether or not the individual or group is authorized for the task within the virtual environment based on the aggregate skill score exceeding a group task authentication threshold.

Monitoring module 230 is configured to monitor the activities of individuals via the network of sensors for the purpose of not only performing analytics of the plurality of activities performed by the individuals, but also in order for activity-based grouping module 150 to identify activity characteristics of the plurality of activities associated with the task. It should be noted that one of the purposes of collecting activity characteristics is to serve as a source of training data for machine learning models directed towards predicting what skills and activities are necessary in order to ascertain the group task authentication threshold for a particular task. The group task authentication threshold is directly correlated to the amount of skills, experience, and qualification necessary in order to efficiently accomplish the particular task at both an individual level and group level.

Machine learning module 240 is configured to use one or more heuristics and/or machine learning models for performing one or more of the various aspects as described herein. In some embodiments, the machine learning models may be performed using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are considered to be within the scope of this disclosure. In some embodiments, machine learning module 240 utilizes one or more machine learning algorithms to train machine learning models in which the output of at least one of the machine learning models is the group task authentication threshold. For example, data pertaining to skills, qualifications, experience, personality traits, personal values, etc. are collected from the network of sensors and/or server 120 and utilized as training data for the one or more machine learning models in order for machine learning module 240 to generate predictions pertaining to requirements of a particular task (e.g. skills, access credentials, etc.) and/or the group task authentication threshold that the group formed by activity-based grouping module 150 needs to exceed in order to be granted authorization by authorization module 140. It should be noted that authorization module 140 granting access to an individual or group for a particular task is based upon the aggregate skill score of the group exceeding the group task authentication threshold in addition to authorization module 140 communicating with security access module 160 in order to assure that there are no issues with access control lists and/or security credentials for each individual of the group and the group as a whole. In some embodiments, server 120 and/or authorization module 140 may ascertain one or more skill gaps based on detecting that the aggregate skill score of the group does not exceed the group task authentication threshold. In such an instance when the threshold is not met or exceeded, the machine learning module 240 may generate recommendations relating to solving the skill gap. Virtualization component 220 may assign visual indicators (e.g. color-coded lighting, symbols, etc.) to individuals within the virtual environment that are not within a particular group who have the skills, qualifications, etc. to rectify the skill gap. This functionality provides a searching mechanism for the virtual environment in which qualified individuals within proximity of the particular task and/or the associated restricted area may be identified for possible inclusion in the group formulated by activity-based grouping module 150. In some embodiments, server 120 supports a temporal proximity function based on data received from Internet of Things (IOT) sensors in order to ascertain if it is feasible for an individual to potentially join a group. For example, a physician may be the missing component to fulfill the threshold for a particular task; however, the physician may not be within a reasonable proximity to the rest of the group and/or the site of the task. Thus, the data derived from the IOT sensors allows server 120 to ascertain both the proximity of the physician and whether it is feasible for the physician to be able to join the group within a reasonable time. If server 120 determines that the physician is within a reasonable proximity then server 120 instructs activity-based grouping module 150 to transmit to the physician an invitation to join the group.

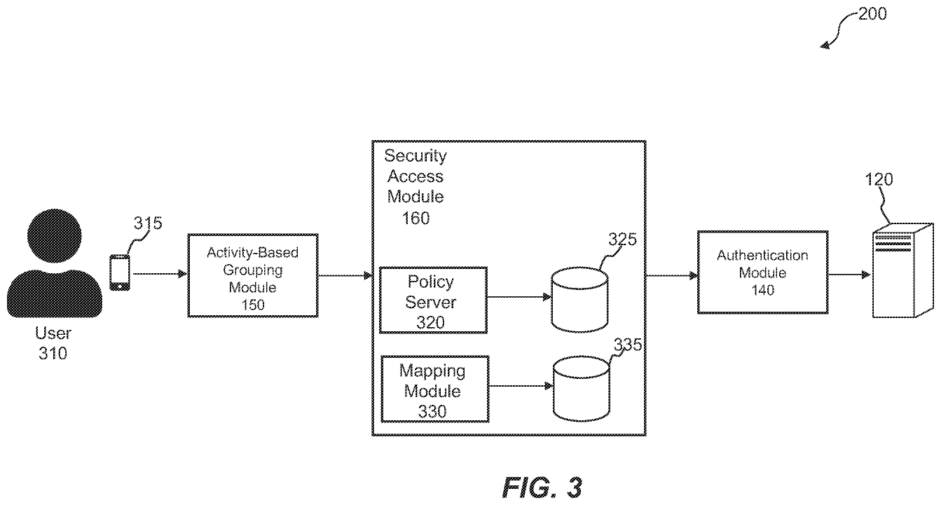

Referring to FIG. 3, a data flow 300 associated with environment 100 is depicted, according to an exemplary embodiment. A user 310 associated with a computing device 315 provides data including but not limited to skills, qualifications, licenses, personality traits, personal values, biological information, movement data, location data, etc. It should be noted that the aforementioned data may be collected from sensors associated with computing device 315, inputs by user 310 on computing device 315 provided via a graphical user interface that is generated by activity-based grouping module 150, and/or server 120 (including applicable third party sources). Said data is transmitted to activity-based grouping module 150 in order to allocate user 310 to the appropriate group based upon the alignment between user 310 and the particular group and particular task. In some embodiments, server 120 evaluates a particular task in order to ascertain the details and requirements associated with the task (e.g. required number of individuals necessary to complete the task, skills/requirements of the plurality of activities, restricted area(s) associated with the task, etc.). Based on the evaluation, activity-based grouping module 150 identifies candidate individuals for a group to perform the particular task. In some embodiments, activity-based grouping module 150 also identifies candidate individuals based on relationship information (e.g. social media connections, frequent contacts, etc.), proximity to areas associated with particular tasks, individual activity history data (e.g. actions, insights, and preferences of user 310 within the virtual environment, etc.), and any other applicable data configured to assist grouping parties or resources. It should be noted that formation of groups may be persistent (e.g. family, friends), proximity based, interest specific, goal specific (e.g. workforce related goals), etc. Activity-based grouping module 150 is further configured to identify the plurality of activities specific to a particular task in which each activity may be unique to the restricted area associated with the particular task, and a plurality of activity characteristics/properties of the particular task. In some embodiments, activity-based grouping module 150 is configured to receive data from Internet of Things (IOT) sensor feeds, camera feeds, etc. in order to identify the plurality of activities and activity characteristics/properties via image analysis, video analysis, computer visioning, and any other applicable type of media analysis technology. This feature also allows real-time analysis of performance of said activities at both an individual level and a group level along with analysis of the synergy amongst the group. The plurality of activity characteristics/properties include metadata relating to type of skill necessary to complete the activity, difficulty/complexity associated with the activity, number of individuals necessary to complete the activity (e.g. only an individual required or the entire group), etc. In some embodiments, the plurality of activity characteristics/properties are not only transmitted to security access module 160, but are also configured to assist establishment of the group task authentication threshold. For example, a mine rescue operation requires a firefighter, at least one doctor, a material movement team, a mechanics team, etc. Due to the fact that each individual and/or team has a different skill, activity-based grouping module 150 identifies which particular skills are required for the mine rescue operation once the plurality of activities of the mine rescue operations are identified.

Subsets of applicable data acquired by server 120 (e.g. skills, experience, etc. of user 310) along with the plurality of activity characteristics/properties are transmitted to security access module 160, allowing security access module 160 to utilize a policy server 320 to establish the applicable group policies and/or security access control lists for the particular task, and manage the access group policies within a policy database 325. The policies may be based on the security configurations associated with the venues of the particular task along with the volume of the activities or required skills associated with the particular task. In some embodiments, security access module 160 further includes a mapping module 330 configured to utilize one or more machine learning models in order to map the skills of user 310 with the access group policies based upon the particular task of the particular group to which the user 310 is assigned. For example, in the instance in which user 310 is a specialized bioinformatics scientist and the particular task is researching a biosphere with restricted access, mapping module 330 maps the skills or a subset of skills of user 310 to the appropriate access group policies that grant user 310 access to the restricted area and stores the applicable mappings in an access mapping database 335. In some embodiments, the mappings may be further based on the skills necessary to complete the plurality of activities of the particular task in light of the applicable access group policies. Access mapping database 335 may be a collection of databases that include lists of resources associated with tasks within environment 100 and the access group policies assigned to each task. In some embodiments, each mapping includes a unique identifier which is utilized by security access module 160 to monitor assignment of a plurality of security credentials issued to each individual of the group formulated by activity-based grouping module 150. However, the plurality of security credentials are not issued to the group until authorization module 140 has determined that the aggregate skill score exceeds the group task authentication threshold. Policy server 320 updates the access group policies as groups are modified and/or terminated. For example, upon the role of user 310 in the group being terminated, policy server 320 instructs security access module 160 to terminate the functionality of the applicable security credential previously assigned to user 310.

Upon authorization module 140 determining that the aggregate skill score exceeds the group task authentication threshold, authorization module 140 instructs security access module 160 to issue the plurality of security credentials to the group resulting in the group being granted access to the restricted area associated with the particular task if applicable. In some embodiments, the granting of access allows user 310 to perform a particular activity of the plurality of activities that user 310 has the skills, credentials, experience, etc. to render, and this may be based on an aggregation of task authentication credentials derived from the mapping of skills of the group to skills required for activities of the task. Visualizations of granted access to the individuals and the group are applied respectively within the virtual environment allowing other users to view which group the individual has been assigned to and relevant access privileges.

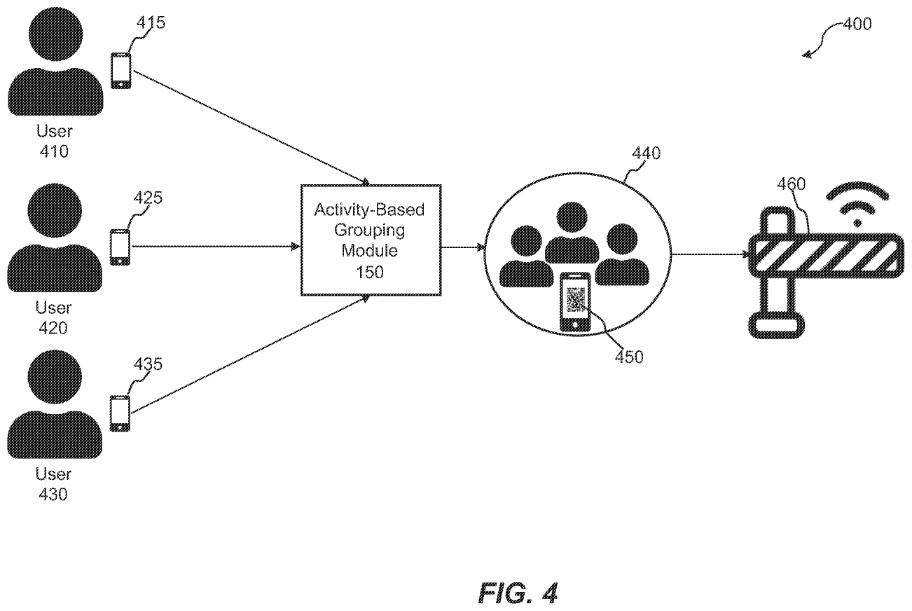

Referring now to FIG. 4, a task-based grouping 400 of users of environment 100 is depicted, accordingly to an exemplary embodiment. Users 410, 420, and 430 access the centralized platform and/or the virtual environment via computing devices 415, 425, and 435 respectively. In some embodiments, at least one of users 410, 420, 430 is a robot configured to be evaluated based on skills, experience, credentials, etc. similarly to non-robotic users in order for activity-based grouping module 150 to formulate a group 440 designed to complete a particular task. It should be noted that group 440 is formed by activity-based grouping module 150 with the intention of developing a collaboration of individuals competent to accomplish the particular task in the most effective manner. In particular, activity-based grouping module 150 calculates the aggregate skill score for group 440 by individually evaluating each of users 410, 420, 430 for the particular task based on data acquired from one or more of computing devices 415, 425, 435, and/or server 120. As previously mentioned, the evaluation of each individual takes into consideration the skills, requirements, location, etc. of the particular task in order to determine if there is an alignment between the particular task and the skills, experience, etc. of the individuals. For example, location data of an individual may support the decision whether it is feasible for individual to be added to a group. Comparison of the aggregate skill score of group 440 to the group task authentication threshold allows authorization module 140 to ascertain skill gaps in the instances in which group 440 is missing components, skills, individuals, etc. necessary in order to complete the particular task in the most efficient manner. It should be noted that the particular task may require different skillsets for the activities distributed across users 410, 420, and 430, in which activity-based grouping module 150 may specify which individual(s) is to perform each activity. It should also be noted that it is possible for users 410, 420, and 430 to be a part of other groups in which the aggregate skill score is a compilation of each individual's evaluation in light of the particular task that activity-based grouping module 150 is analyzing; therefore, the aggregate skill score may not be group-specific but rather a result of the aggregation of individual evaluations in light of the particular task.

Activity-based grouping module 150 forming group 440 and evaluating group 440 in the aforementioned aggregated manner supports authorization module 140 ascertaining skill gaps based on the aggregate skill score not exceeding the group task authentication threshold; however, group 440 having access to a restricted area and/or secured entry 460 is dependent upon the aggregate skill score exceeding the group task authentication threshold. In some embodiments, a report is generated by activity-based grouping module 150 when the aggregate skill score is not exceeded, in which the report includes potential risks associated with proceeding with the current task without the skill gap being fulfilled. Authorization module 140 granting group 440 access to entry 460 is based upon the access group policies generated by policy server 320, in which security access module 160 generates an access code 450 for each of users 410, 420, and 430 based upon at least one of the access group policies. In some embodiments, users 410, 420, and 430 may each have access to entry 460 based upon distinct access group policies allocated by security access module 160. For example, although users 410, 420, and 430 are a part of group 440 each of their respective access codes 450 may be activated at different times assuring that group 440 has access to entry 460 in accordance with their respective access group policies (e.g. access codes are activated at different designated time slots to ensure compliance associated with the task). In some embodiments, security access module 160 activates access codes 450 based upon activity-based grouping module 150 determining that a minimum number of individuals required to complete an activity of the particular task are present. Access code 450 may be a password, an encoded scannable two-dimensional pattern such as a QR code presented to computing devices 415, 425, and 435 respectively, NFC tags, beacons, and/or any other applicable security-based wireless entry mechanisms known to those of ordinary skill in the art. Access code 450 may also account for physical mechanisms for access such as entry cards, badges, etc. In some embodiments, access code 450 may be activated based on identified biometrics of users 410, 420, and 430 if applicable (e.g. iris scanning, fingerprint scanning, etc.). FIG. 4 depicts access code 450 linked to entry 460; however, entry 460 may be any applicable element or component associated with the particular task such as a secured room, a resource/object, an access point, an unlockable data source, etc. In some embodiments, security access module 160 communicates with both authorization module 140 and activity-based grouping module 150 before issuing access code 450 in order to ensure that minimum requirements associated with the particular task are present within group 440 such as, but not limited to minimum number of individuals for an activity, type of skills needed for an activity, etc. Access may be granted by authorization module 140 to a particular individual upon determining said individual fulfills the skill gap.

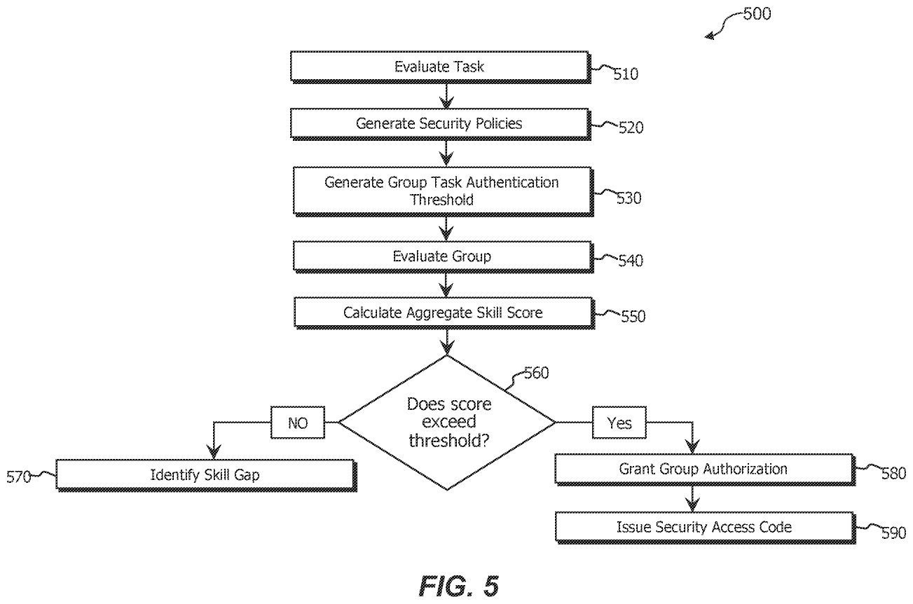

With the foregoing overview of the example architecture, it may be helpful now to consider a high-level discussion of an example process. FIG. 5 depicts a flowchart illustrating a computer-implemented method of process 500 for group-based authentication, consistent with an illustrative embodiment. Process 500 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 510 of process 500, activity-based grouping module 150 evaluates the particular task received by server 120. It should be noted that one of the purposes of evaluating the particular task is to ascertain the complexity of the particular task, the plurality of activities associated with the particular task, workforce requirements (e.g. required number of individuals, required tools/equipment, scheduling requirements, etc.), and any other applicable information associated with efficiently completing the particular task known to those of ordinary skill in the art. During the evaluation of the task, activity-based grouping module 150 is continuously extracting the plurality of activity characteristics/properties associated with the particular task. The activity characteristics/properties may be unique to a designated area or component of the restricted area and/or secured entry 460. In some embodiments, server 120 may provide various data to activity-based grouping module 150 to assist with the evaluations such as data acquired from a plurality of crawlers communicatively coupled to server 120 actively crawling internet-based sources for information regarding the particular task, activities, venue specific data associated with the particular task, and/or users 410, 420, and 430. In some embodiments, data from the aforementioned sources may be utilized by machine learning module 240 in order for one or more of the machine learning models to output predictions relating to the requirements of the particular task.

At step 520 of process 500, security access module 160 instructs policy server 320 to generate the security policies based on the evaluation of the particular task. The security policies include at least once access control list along with access group policy parameters reflecting security or compliance conditions associated with the particular task in relation to group 440 (e.g. extracting information from the evaluation of individuals). For example, the evaluation of the task may reveal a required venue for the particular task in which policy server 320 may generate an access control list specific to the required venue taking into consideration the access group policy parameters (e.g. regulatory compliances, scheduling, etc.).

In some embodiments, policy server 320 generates the security policies based on access control graphs generated by machine learning module 240 reflecting access control allocation and policy parameters specific to the particular task and the required venue. Policy server 320 may perform automatic determination of a higher level access group policy (e.g. based on implemented rules and other attributes associated with tasks and users), which may be performed using clustering, machine learning, and artificial intelligence (AI). Automatic policy determination based on an implemented access control rule base and/or attributes associated with actors and/or objects may facilitate inference of stated policies for a restricted venue or area associated with the particular task. For example, on analyzing the access relationships between users and elements of the particular task, AI techniques may be used to learn and/or infer (e.g. from access logs, activity logs, and/or other system logs) that access from a specific user to a specific element/resource of the particular task may only be allowed when circumstances align with the current security policy or those generated in the past. In some embodiments, automatic policy determination may be used as part of an access control verification process to verify that an implemented rule base reflects stated policies for environment 100 to determine any inconsistencies. For example, derived polices, which may include learned/inferred rules may be compared with a stated access group policy (or rule) to determine potential inconsistencies. In some embodiments, access control verification may be run periodically, and/or whenever access control policies are changed, and/or whenever new tasks, groups, users, etc. are added to existing infrastructure.

At step 530 of process 500, authentication module 140 generates the group task authentication threshold. As previously mentioned, the group task authentication threshold is directly correlated to the amount of skills, experience, qualifications, etc. derived from the evaluation of the particular task. In some embodiments, group task authentication threshold is derived from one or more outputs of machine learning module 240 in which predictions relating to the plurality of activities, required skills, required experience, required number of individuals, etc. are generated and factored into the generation of the group task authentication threshold. In addition, the group task authentication threshold may be used as a point of reference in order for activity-based grouping module 150 to determine one or more skill gaps associated with group 440 if applicable.

At step 540 of process 500, activity-based grouping module 150 evaluates group 440. It should be noted that activity-based grouping module 150 evaluates each user of group 440 individually and collectively in regards to the particular task. Activity-based grouping module 150 evaluates the skills, amount of experience, credentials, geographic location, licenses, personality traits, personal values, biological information, etc. of each user in group 440 in order to determine whether the individual is qualified to perform one or more activities of the plurality of activities. In some embodiments, activity-based grouping module 150 may detect the one or more skill gaps based on the evaluation and identify an applicable robotic user configured to remedy the one or more skill gaps. The robotic user will be evaluated for capacity to perform the applicable activity and subsequently be integrated into group 440.

At step 550 of process 500, activity-based grouping module 150 calculates the aggregate skill score based on the evaluation. As previously mentioned, the aggregate skill score is a derivative of the evaluation of each individual of group 440 in light of the particular task. Factors that can negatively impact the aggregate skill score include but are not limited to skill gaps, minimum required number of users for the particular task not present, users being outside a predetermined proximity of the particular task, suspicious user activity (e.g. being reported by other users in the virtual environment, etc.), group reliance on a robotic user to complete an activity of the particular task, or any other applicable factors that may impact the ability of a user or group to accomplish the particular task known to those of ordinary skill in the art. In some embodiments, the inability of activity-based grouping module 150 to evaluate a user due to lack of applicable information needed in order to evaluate the user's capability in regards to the particular task is a factor that impacts the aggregate skill score.

At step 560 of process 500, authentication module 140 makes a determination as to whether the aggregate skill score exceeds the group task authentication threshold. It should be noted that the determination may take into consideration the complexity of the particular task or its activities along with the probability of remedying skill gaps or score impacting factors. If the aggregate skill score does not exceed the group task authentication threshold, then step 570 of process 500 occurs in which authentication module 140 monitors for skill gaps and other applicable aggregate skill score impacting factors in order for server 120 to notify the appropriate party as to why group 440 is not configured to accomplish the particular task. Otherwise if the aggregate skill score exceeds the group task authentication threshold, then step 580 of process 500 occurs in which authentication module 140 instructs security access module 160 to grant applicable access/authorization to group 440 to perform the particular task.

At step 590 of process 500, security access module 160 generates access/authorization to group 440 to accomplish the particular task. In some embodiments, mapping module 330 maps the skills, credentials, scheduling, etc. associated with each individual of group 440 to the applicable control list policies stored in mapping database 335. Based on the mapping, security access module 160 creates the access code for each of user of group 440 resulting in each user having access to an area, resource, and/or activity associated with the particular task subject to the policy parameters of applicable access group policies. Access credentials generated by security access module 160 may be aggregated in a group-based manner based on the mapping. For example, if a user of group 440 has a higher level of access than the remaining users then the aggregation of the access credentials associated with the particular task may be normalized across group 440 based on the mapping. Once access credentials have been granted by security access module 160, activity-based grouping module 150 may continue to utilize data derived from IOT sensors in order to ascertain analytics associated with the performance and completion of the task at an individual and group level. The IOT sensor-derived data may be utilized as a source of training data by machine learning module 240 in order to generate predictions relating to required skillsets and group task authentication threshold for particular tasks. Data associated with the particular task and the candidate group may also be utilized as a training data source in order for machine learning module 240 to generate predictions relating to whether or not security access module 160 will grant access for a group, and other applicable machine-learning based predictions. For example, machine learning module 240 may generate predictions associated with requirements for performance of tasks and/or elements necessary in order to render the task at an individual level and a group level.

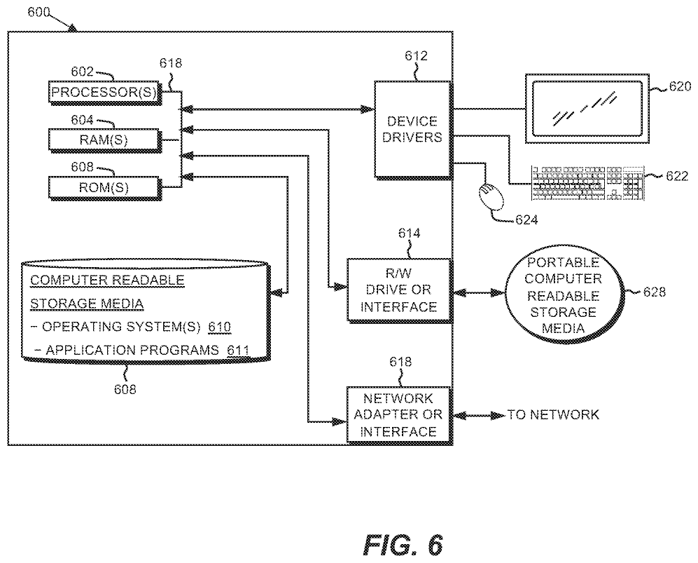

FIG. 6 is a block diagram of components 600 of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 602, 604 is representative of any electronic device capable of executing machine-readable program instructions. Data processing system 602, 604 may be representative of a smart phone, a computer system, PDA, or other electronic devices. Examples of computing systems, environments, and/or configurations that may represented by data processing system 602, 604 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices. The one or more servers may include respective sets of components illustrated in FIG. 6. Each of the sets of components include one or more processors 602, one or more computer-readable RAMs 608 and one or more computer-readable ROMs 610 on one or more buses 602, and one or more operating systems 614 and one or more computer-readable tangible storage devices 616. The one or more operating systems 614 may be stored on one or more computer-readable tangible storage devices 616 for execution by one or more processors 602 via one or more RAMs 608 (which typically include cache memory). In the embodiment illustrated in FIG. 6, each of the computer-readable tangible storage devices 616 is a magnetic disk storage device of an internal hard drive. Alternatively, each of the computer-readable tangible storage devices 616 is a semiconductor storage device such as ROM 610, EPROM, flash memory or any other computer-readable tangible storage device that can store a computer program and digital information.

Each set of components 600 also includes a R/W drive or interface 614 to read from and write to one or more portable computer-readable tangible storage devices 608 such as a CD-ROM, DVD, memory stick, magnetic tape, magnetic disk, optical disk or semiconductor storage device. A software program can be stored on one or more of the respective portable computer-readable tangible storage devices 608, read via the respective RAY drive or interface 618 and loaded into the respective hard drive.

Each set of components 600 may also include network adapters (or switch port cards) or interfaces 616 such as a TCP/IP adapter cards, wireless wi-fi interface cards, or 3G or 4G wireless interface cards or other wired or wireless communication links. Applicable software can be downloaded from an external computer (e.g. server) via a network (for example, the Internet, a local area network or other, wide area network) and respective network adapters or interfaces 616. From the network adapters (or switch port adaptors) or interfaces 616, the centralized platform is loaded into the respective hard drive 608. The network may comprise copper wires, optical fibers, wireless transmission, routers, firewalls, switches, gateway computers and/or edge servers.

Each of components 600 can include a computer display monitor 620, a keyboard 622, and a computer mouse 624. Components 600 can also include touch screens, virtual keyboards, touch pads, pointing devices, and other human interface devices. Each of the sets of components 600 also includes device processors 602 to interface to computer display monitor 620, keyboard 622 and computer mouse 624. The device drivers 612, R/W drive or interface 618 and network adapter or interface 618 comprise hardware and software (stored in storage device 604 and/or ROM 606).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g. mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g. country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g. storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g. web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g. host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g. mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g. cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

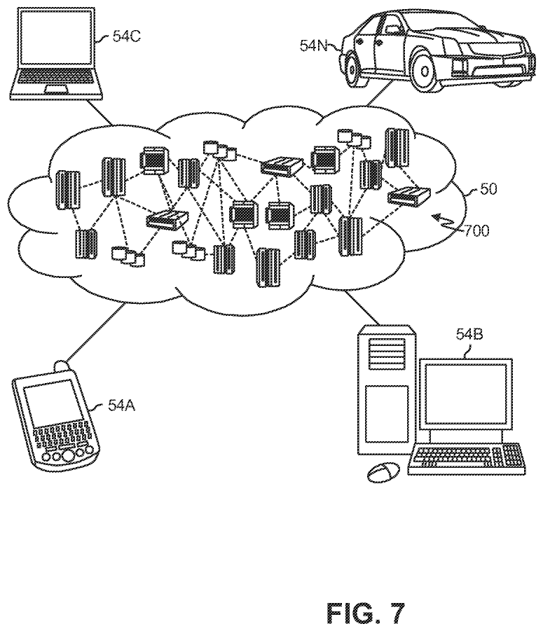

Referring now to FIG. 7, illustrative cloud computing environment 700 is depicted. As shown, cloud computing environment 700 comprises one or more cloud computing nodes 50 with which local computing devices used by cloud consumers, such as, for example, personal digital assistant (PDA) or cellular telephone 54A, desktop computer 54B, laptop computer 54C, and/or automobile computer system 54N may communicate. Nodes 50 may communicate with one another. They may be grouped (not shown) physically or virtually, in one or more networks, such as Private, Community, Public, or Hybrid clouds as described hereinabove, or a combination thereof. This allows cloud computing environment 700 to offer infrastructure, platforms and/or software as services for which a cloud consumer does not need to maintain resources on a local computing device. It is understood that the types of computing devices 54A-N shown in FIG. 7 are intended to be illustrative only and that computing nodes 50 and cloud computing environment 700 can communicate with any type of computerized device over any type of network and/or network addressable connection (e.g. using a web browser).

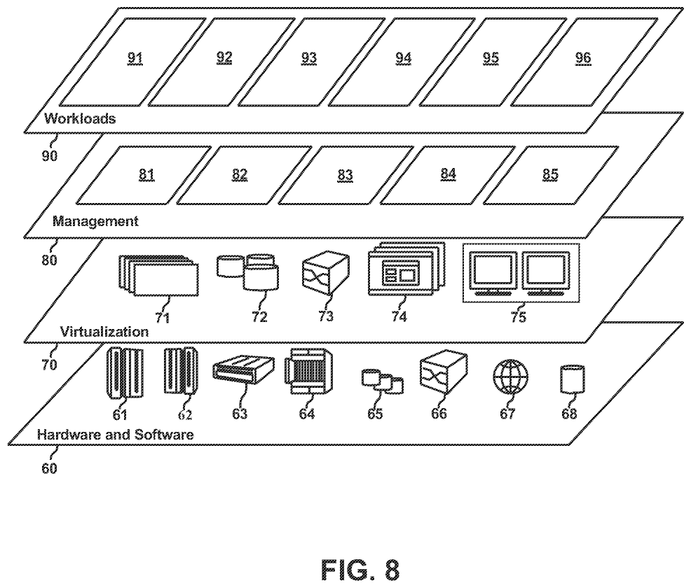

Referring now to FIG. 8 a set of functional abstraction layers provided by cloud computing environment 700 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for group-based authentication comprising:
evaluating, by a computing device, each individual of a group for qualification for a task to acquire an aggregate skill score associated with the group;
based on the evaluation, determining, by the computing device, the aggregate skill score exceeds a group task authentication threshold; and
responsive to the determination, granting the group authorization associated with the task.

2. The computer-implemented method of claim 1, wherein the evaluating comprises:
determining, by the computing device, a group policy associated with the task;
wherein the aggregate skill score is based at least in part on the group policy and the group policy is a guideline for security or compliance conditions associated with the task.

3. The computer-implemented method of claim 2, wherein determining the group policy comprises:
determining, by the computing device, a plurality of activities associated with the task;
determining, by the computing device, a subset of the plurality of skills necessary to complete the plurality of activities; and
identifying, by the computing device, a minimum number of the individuals necessary to fulfill the task.

4. The computer-implemented method of claim 3, wherein determining the plurality of activities associated with the task comprises:
utilizing one or more machine learning models configured to generate a plurality of predictions associated with the task;
wherein the plurality of predictions indicate the plurality of activities associated with the task.

5. The computer-implemented method of claim 1, wherein granting the group authorization comprises:
providing an access code associated with the task to the individual;
wherein the access code provides access to a restricted area associated with the task.

6. The computer-implemented method of claim 3, wherein determining the aggregate skill score exceeds the group task authentication threshold comprises:
mapping, by the computing device, the plurality of skills of each individual of the group to the subset of the plurality of skills necessary to complete the plurality of activities; and
aggregating, by the computing device, a plurality of task authentication credentials of each individual of the group based on the mapping.

7. The computer-implemented method of claim 3, wherein each of the plurality of activities includes one or more activity characteristics unique to a designated area associated with the task.

8. A computer program product using a computing device for group-based authentication, comprising:
one or more non-transitory computer-readable storage media and program instructions stored on the one or more non-transitory computer-readable storage media, the program instructions, when executed by the computing device, cause the computing device to perform a method comprising:
evaluating, by a computing device, each individual of a group for qualification for task to acquire an aggregate skill score associated with the group;
based on the evaluation, determining, by the computing device, the aggregate skill score exceeds a group task authentication threshold; and
responsive to the determination, granting the group authorization associated with the task.

9. The computer program product of claim 8, wherein the evaluating further comprises instructions to further cause the computing device to perform:
determining, by the computing device, a group policy associated with the task;
wherein the aggregate skill score is based at least in part on the group policy and the group policy is a guideline for security or compliance conditions associated with the task.

10. The computer program product of claim 9, wherein determining the group policy further comprises instructions to further cause the computing device to perform:
determining, by the computing device, a plurality of activities associated with the task;
determining, by the computing device, a subset of the plurality of skills necessary to complete the plurality of activities; and
identifying, by the computing device, a minimum number of the individuals necessary to fulfill the task.

11. The computer program product of claim 10, wherein determining the group policy further comprises instructions to further cause the computing device to perform:
utilizing one or more machine learning models configured to generate a plurality of predictions associated with the task;
wherein the plurality of predictions indicate the plurality of activities associated with the task.

12. The computer program product of claim 10, wherein determining the aggregate skill score exceeds the group task authentication threshold comprises instructions to further cause the computing device to perform:
mapping, by the computing device, the plurality of skills of each individual of the group to the subset of the plurality of skills necessary to complete the plurality of activities; and
aggregating, by the computing device, a plurality of task authentication credentials of each individual of the group based on the mapping.

13. The computer program product of claim 8, wherein granting the group authorization comprises instructions to further cause the computing device to perform:
providing, by the computing device, an access code associated with the task to the individual;
wherein the access code provides access to a restricted area associated with the task.

14. A computer system for group-based authentication, the computer system comprising:
one or more processors, one or more computer-readable memories, and program instructions stored on at least one of the one or more computer-readable memories for execution by at least one of the one or more processors to cause the computer system to:
program instructions to evaluate each individual of a group for qualification for task to acquire an aggregate skill score associated with the group;
program instructions to determine the aggregate skill score exceeds a group task authentication threshold based on the evaluation; and
program instructions to grant the group authorization associated with the task responsive to the determination.

15. The computer system of claim 14, wherein the program instructions to evaluate each individual comprises:
program instructions to determine a group policy based on a plurality of skills associated with the task;
wherein the aggregate skill score is based at least in part on the group policy and the group policy security conditions associated the task.

16. The computer system of claim 15, wherein the program instructions to determine the group policy comprises:
program instructions to determine a plurality of activities associated with the task;
program instructions to determine a subset of the plurality of skills necessary to complete the plurality of activities; and
program instructions to identify a minimum number of the individuals necessary to fulfill the task.

17. The computer system of claim 16, wherein the program instructions to determine the plurality of activities associated with the task comprises:
program instructions to utilize one or more machine learning models configured to generate a plurality of predictions associated with the task.

18. The computer system of claim 14, wherein the program instructions to grant the group authorization comprises:
program instructions to provide an access code associated with the task to the individual;
wherein the access code provides access to a restricted area associated with the task.

19. The computer system of claim 16, wherein the program instructions to determine the aggregate skill score exceeds the group task authentication threshold comprises:
program instructions to map the plurality of skills of each individual of the group to the subset of the plurality of skills necessary to complete the plurality of activities; and
program instructions to aggregate a plurality of task authentication credentials of each individual of the group based on the mapping.

20. The computer system of claim 16, wherein each of the plurality of activities includes one or more activity characteristics unique to a designated area associated with the task.
